(19) United States
(12) Patent Application Publication
(10) Pub. No.: US 2017/0286060 A1
(43) Pub. Date: Oct. 5, 2017

(54) METHOD FOR SONG SUGGESTION SHARING

(71) Applicant: Panasonic Automotive Systems Company of America, Division of Panasonic Corporation of North America, Peachtree City, GA (US)

(72) Inventors: SHANTHA KUMARI RAJENDRAN, FARMINGTON HILLS, MI (US); PADHU KANAGARAJ, FARMINGTON HILLS, MI (US)

(73) Assignee: Panasonic Automotive Systems Company of America, Division of Panasonic Corporation of North America

(21) Appl. No.: 15/468,260

(22) Filed: Mar. 24, 2017

Related U.S. Application Data
(60) Provisional application No. 62/315,585, filed on Mar. 30, 2016.

(51) Int. Cl. G06F 3/16; H04M 1/60; B60R 16/023; H04M 1/725

(52) U.S. Cl. CPC G06F 3/167; H04M 1/7253; H04M 1/6091; H04M 1/72558; H04M 1/72552; B60R 16/023

(57) ABSTRACT

A motor vehicle includes an audio system which plays a song for a human user who is disposed within the vehicle. An electronic source of song information is associated with the song played by the audio system. A user interface receives a request from the user to transmit the song information to a human recipient. A processing device is communicatively coupled to each of the user interface and a mobile personal electronic device associated with the user. The processing device receives a signal from the user interface. The signal is indicative of the request from the user to transmit the song information to the human recipient. In response to receiving the signal from the user interface, the song information is transmitted from the processing device to the mobile personal electronic device associated with the user. The song information is further transmitted from the mobile personal electronic device associated with the user to an electronic device associated with the recipient.

### CROSS-REFERENCED TO RELATED APPLICATIONS

This application claims benefit of U.S. Provisional Application No. 62/315,585 filed on Mar. 30, 2016, which the disclosure of which is hereby incorporated by reference in its entirety for all purposes.

### FIELD OF THE INVENTION

The disclosure relates to the field of audio systems, and, more particularly, to audio systems in motor vehicles.

### BACKGROUND OF THE INVENTION

Currently, there is no known mechanism to enable a car user share a song with another user while driving.

### SUMMARY

The present invention may enable a user to listen to a song on FM radio or other media sources and share the song with his friends and family. The invention may enable such users to share songs they like with other users as suggestions to listen.

The invention may enable a ear user to share a song with another person, and thereby suggest to the other person that he listen to the song. While listening to a song in the car, if the car user(s) likes the song and would like to share the song with another person, then the car user can press a “share” pushbutton to thereby send the name of the song, the name of the song's artist, and other song-related information to another user via a phone text message. The system may display to the car user a list of pre-stored contact information associated with other users to whom the song information can he sent by use of the contact information.

When the other user receives the contact information on his phone, if the other user's phone is connected to a car radio unit, then the other user can choose to listen to the song via the car radio unit. The other user who receives the song information may also be enabled to play the song on other electronic units such as a computer, cell phone, TV, etc., apart from the car head unit. Internet Radio applications may be used to find the song that is shared, retrieve the song, and play it.

The invention may be implemented in a way that reduces driver distraction by requiring only a minimal number of steps to be performed by the driver. For example, the “share” pushbutton being pressed for a long time duration may be sufficient to send the song to a default contact.

In one embodiment, the invention comprises a motor vehicle including an audio system which plays a song for a human user who is disposed within the vehicle. An electronic source of song information is associated with the song played by the audio system. A user interface receives a request from the user to transmit the song information to a human recipient. A processing device is communicatively coupled to each of the user interface and a mobile personal electronic device associated with the user. The processing device receives a signal from the user interface. The signal is indicative of the request from the user to transmit the song information to the human recipient. In response to receiving the signal from the user interface, the song information is transmitted from the processing device to the mobile personal electronic, device associated with the user. The song information is further transmitted from the mobile personal electronic device associated with the user to an electronic device associated with the recipient.

In another embodiment, the invention comprises a method of sharing a song while in a motor vehicle, including using an electronic audio system to play a song for a human user who is disposed within the vehicle. An electronic source of song information is provided. The song information is associated with the song played by the audio system. A request from the user to transmit the song information to a human recipient is electronically received. In response to receiving the signal from the user interface, the song information is transmitted to a mobile personal electronic device associated with the user. The song information is further transmitted from the mobile personal electronic device associated with the user to an electronic device associated with the recipient.

In yet another embodiment, the invention comprises a motor vehicle including an electronic audio system which plays a song for a human user who is disposed within the vehicle. An electronic source of song information includes data associated with the song played by the audio system. An electronic user interface receives a request from the user to transmit the data associated with the song played by the audio system to a human recipient. An electronic processing device is communicatively coupled to the user interface. The processing device receives a signal from the user interface. The signal is indicative of the request from the user to transmit the data associated with the song played by the audio system to the human recipient. In response to receiving the signal from the user interface, the data associated with the song played by the audio system is transmitted to an electronic device associated with the recipient.

An advantage of the present invention is that it may enable users to easily and quickly share songs they are listening to with friends and relatives.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular song suggestion sharing arrangement of the present invention.

FIG. 2 is a flow chart of one embodiment of a vehicular song suggestion sharing method of the invention.

FIG. 3 is a flow chart of another embodiment of a vehicular song suggestion sharing method of the invention.

FIG. 4 is a flow chart of yet another embodiment of a vehicular song suggestion sharing method of the invention.

FIG. 5 is a flow chart of an embodiment of a method of the present invention for sharing a song while in a motor vehicle.

### DETAILED DESCRIPTION OF THE PREFERRED EMBODIMENTS

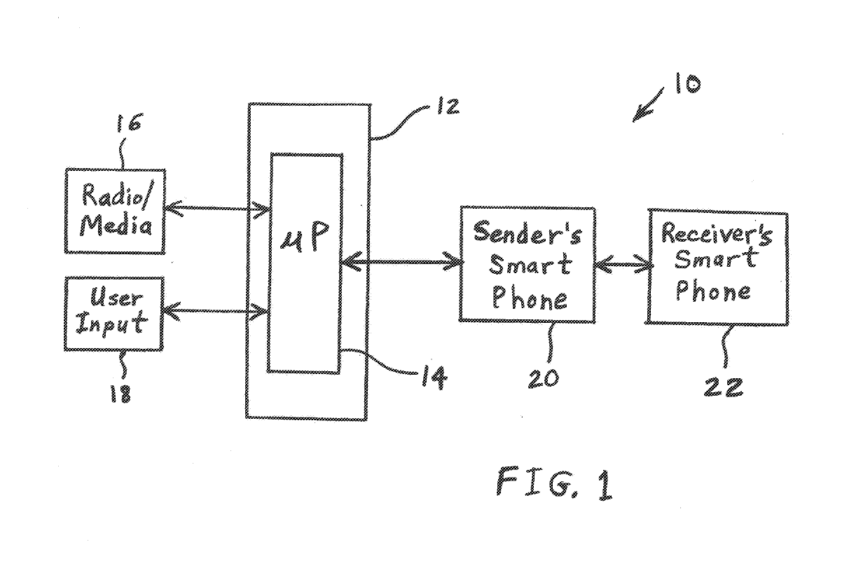

FIG. 1 illustrates one embodiment of a vehicular song suggestion sharing arrangement 10 of the present invention including an infotainment unit 12 having an electronic processor 14 in bi-directional communication with each of a radio/media song information source 16, a user input interface 18, and a human car user's smartphone 20. The car user's smartphone 20 is further in bi-directional direction with a human receiver's smartphone 22.

Infotainment unit 12 and user input interface 18 may be disposed in the car user's car or other vehicle. Radio/media song information source 16 may be disposed in the vehicle, or may be a remote and/or Internet-based source that processor 14 communicates with wirelessly. The car user's smartphone 20 is typically disposed in the vehicle along with the car user, who may also own or use smartphone 20. The receiver's smartphone 22 may also he disposed in the vehicle, along with the human receiver who may also own or use smartphone 22. However, the receiver's smartphone 22 may also be disposed outside of the vehicle anywhere that smartphone 22 may be reached and communicated with via conventional long distance wireless technology, such as cellular technology.

Processor 14 may communicate with radio/media song information source 16 via hard wire or wirelessly through the Internet. Processor 14 may communicate with user input interface 18 via hard wire. Processor 14 may communicate with smartphone 20 via a short distance wireless technology, such as Bluetooth. Smartphones 20, 22 may communicate with each other via conventional cellular technology.

During use, the car user may hear a song that is being played on the car's audio system, and decide that he would like to share the song with a recipient in the form of a friend or relative, for example. In order to share the song, the car user may press a pushbutton on user input interface 18 for a predetermined period of time, which may result in the information of the currently playing song (e.g., the name of the song, the name of the song's artist) being transmitted from radio/media song information source 16 to processor 14. Also as a result of the car user pressing the pushbutton on user input interface 18 for the predetermined period of time, the name of one or more default recipients may he displayed to the ear user. The car user may have the option to change the recipient or add one or more other recipients to receive the song information. However, if the car user takes no further action, then, after another predetermined period of time the song information may be automatically transmitted from processor 14 to the user's smartphone 20, and then be relayed to smartphone(s) 22 of the default recipient(s). The human recipients may then use the received song information to retrieve the song from an Internet-based song repository, or from a song repository in the car, for example.

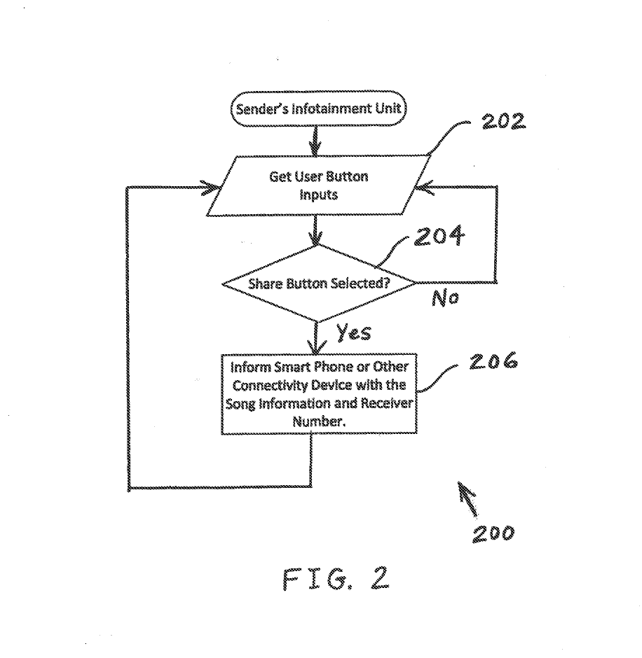

FIG. 2 illustrates one embodiment of a vehicular song suggestion sharing method 200 of the invention. In a first step 202, the user pushbutton inputs are received. For example, it may be sensed that the car user presses a pushbutton on user input interface 18. Next, in step 204, it is determined whether the user has, in particular, pushed the “share” pushbutton on user input interface 18. If not, then operation returns to step 202. Conversely, if it is determined that the “share” pushbutton has been pressed, then operation proceeds to step 206 where the user's smartphone or another communication device is informed of the song information and the phone number of the receiver's smartphone. For example, if it is determined that the “share” pushbutton has been pressed by the car user, then the car user's smartphone 20 may receive from processor 14 the song title, the artist's name, and the phone number of smartphone 22. Operation then returns to step 202.

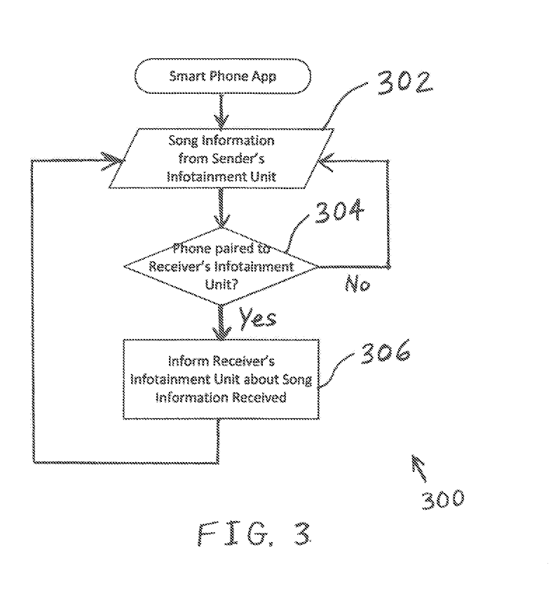

FIG. 3 illustrates another embodiment of a vehicular song suggestion sharing method 300 of the invention. In a first step 302, the song information from the human sender's infotainment unit is received by the smartphone application. For example, the song information (e.g., the song title, the artist's name, etc.) transmitted by a processor of the sender's vehicle's infotainment unit may be received by the receiver's smartphone. Next, in step 304, it is determined whether the smartphone is paired with the infotainment unit of the receiver's automobile. For example, it may be determined whether the receiver's smartphone is paired with the infotainment unit of the receiver's automobile such that the receiver's smartphone may communicate with the infotainment unit via a hard wire or wirelessly (e.g., via Bluetooth). If not, then operation returns to step 302. Conversely, if it is determined that the receiver's smartphone is paired with the infotainment unit of the receiver's automobile, then operation proceeds to step 306 where the receiver's infotainment unit is informed about the song information that was received. For example, the receiver's infotainment unit in the receiver's automobile may be informed about the song information that was received by the receiver's smartphone from the sender's vehicle's infotainment unit. Operation then returns to step 302.

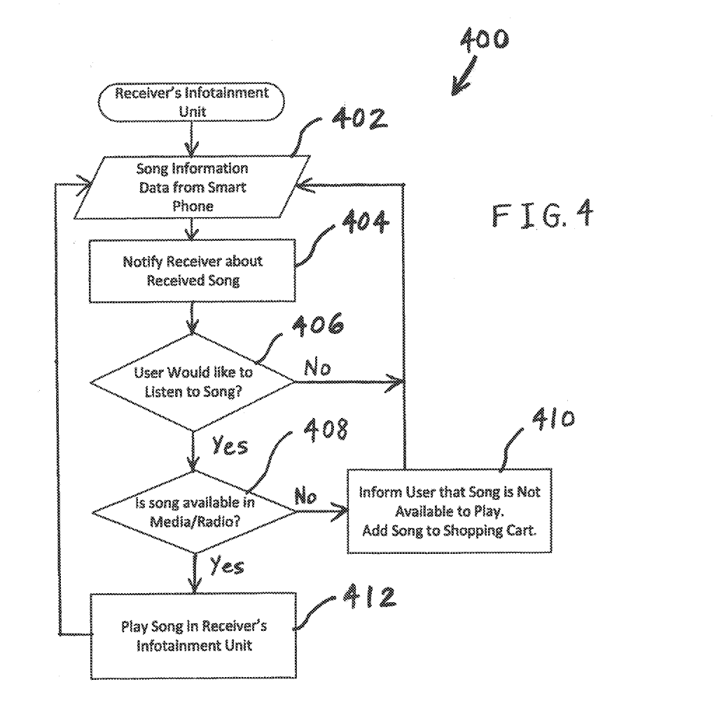

FIG. 4 illustrates yet another embodiment of a vehicular song suggestion sharing method 400 of the invention. In a first step 402, the song information data from the human receiver's smartphone is received. For example, the song information data (e.g., the song title, the artist's name, etc.) may be transmitted by the receiver's smartphone and may be received by the infotainment unit of the receiver's vehicle,

Next, in step 404, the receiver is notified about the received song. For example, the receiver's infotainment unit may display the song information data on a display screen of the infotainment unit, and/or may audibly notify the receiver of the song information data. The receiver's infotainment unit may also notify the receiver visually or audibly that the song information data is related to a song that has been recommended by the sender. The receiver's infotainment unit may further identify the name of the sender to the receiver.

In a next step 406, it is determined whether the user would like to listen to the song. For example, the recipient may press a pushbutton on his infotainment unit user interface to indicate that he would like to listen to the song suggested by the human sender. Alternatively, the recipient may speak to express his desire to listen to the suggested song, such as by saying “play the song”. This audible statement may be detected by use of a microphone on the recipient's infotainment unit user interface. If the recipient does not indicate that he would like to listen to the song, then operation returns to step 402. Conversely, if it is determined that the recipient has indicated that he would like to listen to the song, then operation proceeds to step 408 where it is determined whether the song is available in media/radio. For example, the receiver's infotainment unit may search online Internet music repositories to find the recommended song based on the song information data provided by the sender. Alternatively, the receiver's infotainment unit may search in-vehicle music repositories to find the recommended song based on the song information data provided by the sender if it is determined that the song is not available in media/radio, then operation proceeds to step 410, where the user is informed that the song is not available to play, and the song is added to the shopping cart. For example, the receiver's infotainment unit may display a message that the song cannot be found, and/or may audibly notify the receiver that the song cannot be found. Electronic arrangements may be made to purchase the song for the recipient when the song become available. Operation then returns to step 402. Conversely, if it is determined that the song is available in media/radio, then operation proceeds to step 412 where the song is played in the receiver's infotainment system. For example, the song may be retrieved from the online or in-vehicle music repository, and the retrieved song maybe audibly played on the audio system and loudspeakers within the receiver's vehicle. Operation then returns to step 402.

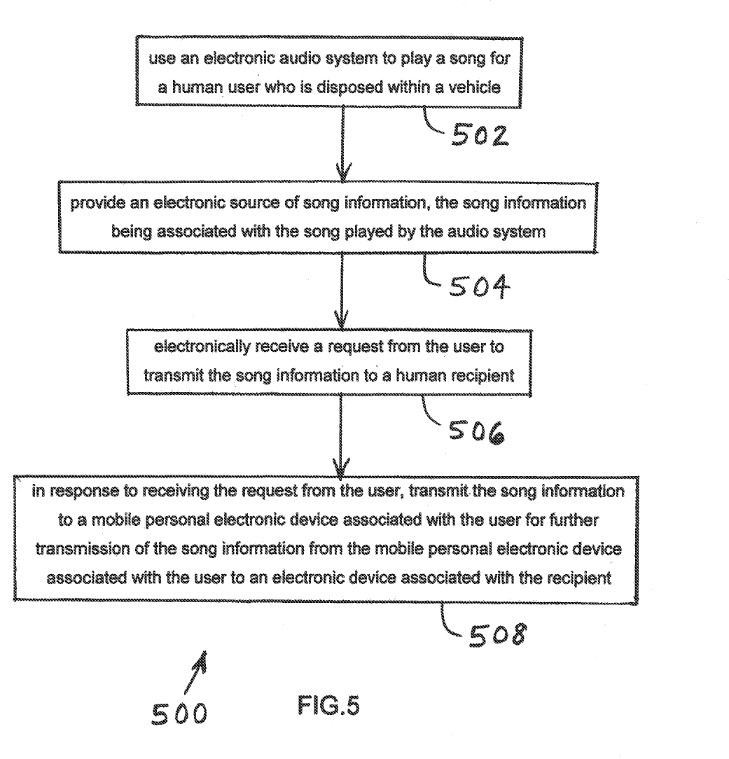

FIG. 5 illustrates an embodiment of a method 500 of the present invention for sharing a song while in a motor vehicle. In a first step 502, an electronic audio system is used to play the song for a human user who is disposed within the vehicle. For example, the vehicle's infotainment unit 12 may include an electronic audio system that plays a song, such as from a radio or compact disc, for a human user in the vehicle.

In a next step 504, an electronic source of song information is provided. The song information is associated with the song played by the audio system. For example, radio/media song information source 16 may be provided in the vehicle, or may be a remote and/or Internet-based source that processor 14 communicates with wirelessly. Radio/media song information source 16 may provide metadata broadcast along with the song on the radio, or metadata read from a compact disc while the associated song is playing.

Next, in step 506, a request from the user to transmit the song information to a human recipient is electronically received. For example, it may be sensed that a human user has pressed a “share” pushbutton on user input interface 18.

In a final step 508, in response to receiving the request from the user, the song information is transmitted to a mobile personal electronic device associated with the user for further transmission of the song information from the mobile personal electronic device associated with the user to an electronic device associated with the recipient. For example, the car user's smartphone 20 may receive from processor 14 the song title, the artist's name, and the phone number of smartphone 22. Smartphone 20 may then transmit the song title and the artist's name to the receiver's smartphone 22.

The invention has been described herein as enabling a user to share a song by pressing a button. However, in another embodiment, instead of pressing a share button, voice commands may be used to Share the song information with contacts.

The invention has been described herein as enabling a user to share a song it is to be understood that, as used herein, a “song” may include both a piece of music accompanied by vocal lyrics, and purely instrumental pieces of music without vocalized lyrics.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
an electronic audio system configured to play a song for a human user who is disposed within the vehicle;
an electronic source of song information, the song information being associated with the song played by the audio system;
an electronic user interface configured to receive a request from the user to transmit the song information to a human recipient; and
an electronic processing device communicatively coupled to each of the user interface and a mobile personal electronic device associated with the user, the processing device being configured to:
receive a signal from the user interface, the signal being indicative of the request from the user to transmit the song information to the human recipient; and
in response to receiving the signal from the user interface, transmit the song information to the mobile personal electronic device associated with the user for further transmission of the song information from the mobile personal electronic device associated with the user to an electronic device associated with the recipient.

2. The motor vehicle of claim 1 wherein the electronic source of song information is disposed outside of the vehicle and is wirelessly accessible from the vehicle.

3. The motor vehicle of claim 1 wherein the electronic source of song information is disposed inside the vehicle.

4. The motor vehicle of claim 1 wherein the song information includes a title of the song and a name of an artist who performed the song.

5. The motor vehicle of claim 1 wherein the electronic device associated with the recipient comprises a mobile personal electronic device,

6. The motor vehicle of claim 1 wherein the electronic user interface includes a pushbutton configured to be pressed by the user to cause the song information to be transmitted to the human recipient.

7. The motor vehicle of claim 1 wherein the electronic user interface includes a microphone configured to detect a spoken command by the user to transmit the song information the human recipient.

8. A method of sharing a song while in a motor vehicle, the method comprising:
using an electronic audio system to play a song for a human user who is disposed within the vehicle;
providing an electronic source of song information, the song information being associated with the song played by the audio system;
electronically receiving a request from the user to transmit the song information to a human recipient; and
in response to receiving the request from the user, transmitting the song information to a mobile personal electronic device associated with the user for further transmission of the song information from the mobile personal electronic device associated with the user to an electronic device associated with the recipient.

9. The method of claim 8 wherein the electronic source of song information is disposed outside of the vehicle and is wirelessly accessible from the vehicle.

10. The method of claim 8 wherein the electronic source of song information is disposed inside the vehicle.

11. The method of claim 8 wherein the song information includes information sufficient to purchase the song online.

12. The method of claim 8 wherein the electronic device associated with the recipient comprises a mobile personal electronic device.

13. The method of claim 8 wherein the electronically receiving step includes sensing the user pressing a pushbutton on an electronic user interface.

14. The method of claim 8 wherein the electronically receiving step includes sensing the user audibly speaking a command.

15. A motor vehicle, comprising:
an electronic audio system configured to play a song for a human user who is disposed within the vehicle;
an electronic source of song information, the song information including data associated with the song played by the audio system;
an electronic user interface configured to receive a request from the user to transmit the data associated with the song played by the audio system to a human recipient; and
an electronic processing device communicatively coupled to the user interface, the processing device being configured to:
receive a signal from the user interface, the signal being indicative of the request from the user to transmit the data associated with the song played by the audio system to the human recipient; and
in response to receiving the signal from the user interface, transmit the data associated with the song played by the audio system to an electronic device associated with the recipient.

16. The motor vehicle of claim 15 wherein the electronic source of song information is disposed outside of the vehicle and is wirelessly accessible from the vehicle,

17. The motor vehicle of claim 15 wherein the electronic source of song information is disposed inside the vehicle.

18. The motor vehicle of claim 15 wherein the song information includes a title of the song and a name of an artist who performed the song.

19. The motor vehicle of claim 15 wherein the electronic device associated with the recipient comprises a mobile personal electronic device.

20. The motor vehicle of claim 15 wherein the electronic user interface includes a pushbutton configured to be pressed by the user to cause the song information to he transmitted to the human recipient.

21. The motor vehicle of claim 15 wherein the electronic user interface includes a microphone configured to detect a spoken command by the user to transmit the song information the human recipient.
